(19) United States
(12) Patent Application Publication
(10) Pub. No.: US 2025/0138135 A1
(43) Pub. Date: May 1, 2025

(54) INFORMATION PROCESSING DEVICE, INFORMATION PROCESSING METHOD, AND PROGRAM

(71) Applicant: Sony Semiconductor Solutions Corporation, Kanagawa (JP)

(72) Inventors: Hiroaki Nakano, Tokyo (JP); Toru Terashima, Kanagawa (JP); Uichiro Omae, Kanagawa (JP)

(21) Appl. No.: 18/834,581

(22) PCT Filed: Feb. 15, 2023
(86) PCT No.: PCT/JP23/05243

§ 371 Date: Jul. 30, 2024

(30) Foreign Application Priority Data
Mar. 18, 2022 (JP) 2022-044274

(51) Int. Cl. G01S 5/14; G01S 3/48; G01S 5/02; G01S 5/12

(52) U.S. Cl. CPC G01S 5/14; G01S 3/48; G01S 5/0218; G01S 5/12

(57) ABSTRACT

An information processing device includes a determination processing unit which makes a use determination on a radio wave arrival angle on the basis of a plurality of pieces of phase information, each of the plurality of pieces of phase information being phase information of a signal propagation path for each set of a transmission antenna and a reception antenna, and being calculated for a corresponding frequency of a wireless signal propagated through the signal propagation path.

### TECHNICAL FIELD

The present technology relates to an information processing device, an information processing method, and a program, and particularly relates to a technology related to positioning using a radio wave arrival angle.

### BACKGROUND ART

In an indoor positioning technology, it is difficult to receive a satellite radio wave, and thus, a method not using a satellite radio wave has been proposed. As the indoor positioning technology, there are roughly two methods. One is a method of specifying a position on the basis of distance information from a plurality of base stations, and the other is a method of specifying a position on the basis of distance information from a base station and a radio wave arrival angle.

However, measurement of the radio wave arrival angle has many problems, and for example, the radio wave arrival angle calculated under an environment where the influence of multipath is large has low reliability, and the error of the positioning result becomes large.

In order to solve this problem, Patent Document 1 below proposes a method of determining which of a main lobe and a side lobe is correct by performing outlier detection.

### CITATION LIST

### Patent Document

Patent Document 1: Japanese Patent Application Laid-Open No. 2020-71123

### SUMMARY OF THE INVENTION

### Problems to be Solved by the Invention

Patent Document 1 describes estimating a radio wave arrival angle a plurality of times and considering a difference from a tracking prediction value.

However, these are based on the premise that the user is constantly moving, and in a case where the user continues to stay at the same position, there is a possibility that radio wave arrival angles each having a large error are consecutively measured, and a positioning result of the user includes a large error.

The present technology is intended to solve the problem described above, and an object thereof is to appropriately determine whether or not a radio wave arrival angle should be trusted.

### Solutions to Problems

An information processing device according to the present technology includes a determination processing unit which makes a use determination on a radio wave arrival angle on the basis of a plurality of pieces of phase information, each of the plurality of pieces of phase information being phase information of a signal propagation path for each set of a transmission antenna and a reception antenna, and being calculated for a corresponding frequency of a wireless signal propagated through the signal propagation path.

The radio wave arrival angle is erroneously detected in some cases depending on an environment in which the wireless signal is transmitted and received. According to the present configuration, it is possible to determine whether or not to use the radio wave arrival angle on the basis of the phase information of the signal propagation path.

An information processing method according to the present technology includes by an arithmetic processing device, making a use determination on a radio wave arrival angle on the basis of a plurality of pieces of phase information, each of the plurality of pieces of phase information being phase information of a signal propagation path for each set of a transmission antenna and a reception antenna, and being calculated for a corresponding frequency of a wireless signal propagated through the signal propagation path.

A program of the present technology is a program readable by a computer device, the program causing the computer device to realize a function of making a use determination on a radio wave arrival angle on the basis of a plurality of pieces of phase information, each of the plurality of phase information being phase information of a signal propagation path for each set of a transmission antenna and a reception antenna, and being calculated for a corresponding frequency of a wireless signal propagated through the signal propagation path.

### BRIEF DESCRIPTION OF DRAWINGS

FIG. 1 is a view illustrating a state in which wireless communication is performed between a mobile terminal device and a communication device according to an embodiment of the present technology.

FIG. 2 is a block diagram illustrating an internal configuration example of an information processing device according to the embodiment.

FIG. 3 is a block diagram illustrating an internal configuration example of a wireless communication module of the information processing device according to the embodiment.

FIG. 4 is a diagram illustrating a mode example of phase measurement in a phase based method, together with FIG. 5.

FIG. 5 is a diagram illustrating the mode example of phase measurement in the phase based method, together with FIG. 4.

FIG. 6 is an explanatory diagram of a phase of a signal propagation path measured in the phase based method.

FIG. 7 is a diagram for explaining a phase characteristic with respect to a frequency of the signal propagation path, together with FIG. 8.

FIG. 8 is a diagram for explaining the phase characteristic with respect to the frequency of the signal propagation path, together with FIG. 7.

FIG. 9 is a functional block diagram illustrating functions of a CPU of the information processing device.

FIG. 10 is a diagram for explaining calculation of a radio wave arrival angle by using a configuration of a plurality of transmission antennas and one reception antenna.

FIG. 11 is a diagram for explaining calculation of a radio wave arrival angle by using a configuration of one transmission antenna and a plurality of reception antennas.

FIG. 12 is a diagram for explaining a signal propagation path through which a radio wave reaches via an obstacle and a signal propagation path through which a radio wave reaches via a reflector.

FIG. 13 is a diagram illustrating a frequency characteristic of the phase obtained for each combination of a transmission antenna and a reception antenna.

FIG. 14 is a diagram illustrating a phase characteristic of the signal propagation path acquired in a good communication environment.

FIG. 15 is a diagram illustrating a phase characteristic of the signal propagation path acquired in a poor communication environment.

FIG. 16 is a diagram illustrating a comparison result of inclinations of phase characteristics with respect to the frequency of the signal propagation path acquired in the good communication environment and the poor communication environment.

FIG. 17 is a diagram illustrating results of converting the frequency characteristic of the phase acquired in a good communication environment into time-axis waveform data by inverse Fourier transform.

FIG. 18 is a diagram illustrating results of converting the frequency characteristics of the phase acquired in a poor communication environment into time-axis waveform data by inverse Fourier transform.

FIG. 19 is a diagram illustrating a histogram of individual radio wave arrival angles acquired in a good communication environment.

FIG. 20 is a diagram illustrating a histogram of individual radio wave arrival angles acquired in a poor communication environment.

FIG. 21 is a diagram illustrating a flow of processing executed by each device in the first embodiment.

FIG. 22 is a flowchart of part of processing executed by the communication device as the information processing device.

FIG. 23 is a flowchart of part of processing executed by a communication device as an information processing device according to a second embodiment.

FIG. 24 is a diagram for explaining an example of a positioning method, together with FIG. 25.

FIG. 25 is a diagram for explaining the example of the positioning method, together with FIG. 24.

### MODE FOR CARRYING OUT THE INVENTION

Hereinafter, embodiments will be described in the following order.
<1. First Embodiment>
<1-1. Configuration Example of Positioning System>
<1-2. Hardware Configuration of Information Processing Device>
<1-3. Distance Measurement by Phase Based Method>
<1-4. Functional Blocks of Information Processing Device>
<1-5. Communication Quality Evaluation Value>
<1-6. Flow of Processing>
<2. Second Embodiment>
<3. Modifications>
<4. Summary>
<5. Present Technology>

### 1. First Embodiment

### <1-1. Configuration Example of Positioning System>

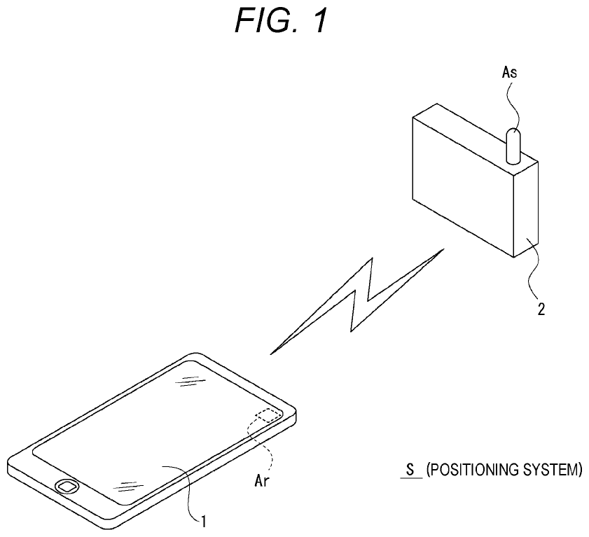

FIG. 1 illustrates a configuration example of a positioning system S according to a first embodiment of the present technology.

The positioning system S includes a mobile terminal device 1 and a communication device 2 capable of performing wireless communication with the mobile terminal device 1. Note that the positioning system S may include two or more communication devices 2 for one mobile terminal device 1.

The mobile terminal device 1 is a computer device which includes a microcomputer including a central processing unit (CPU), a read only memory (ROM), a random access memory (RAM), and the like. The mobile terminal device 1 is a device that can be carried by a user, such as a smartphone, a tablet terminal, or a remote controller, for example. The mobile terminal device 1 in the present example is a smartphone.

Near field communication can be performed between the mobile terminal device 1 and the communication device 2. In the present example, wireless communication by a Bluetooth (registered trademark) low energy (BLE) method is possible. Therefore, the communication device 2 is a device that functions as a BLE beacon.

The positioning system S includes an information processing device that measures the position of the mobile terminal device 1 with respect to the communication device 2. The information processing device may be the mobile terminal device 1, the communication device 2, or a device different from each of these devices. In the present example, an example in which the communication device 2 executes various processes for positioning as the information processing device will be described.

Note that, in a case of referring to an information processing device that performs various processes for positioning without distinguishing the mobile terminal device 1, the communication device 2, and another device, it is simply referred to as an “information processing device M”.

The information processing device M measures (determines) the position of the mobile terminal device 1, that is, the position of the user who possesses the mobile terminal device 1, with respect to the communication device 2.

Positioning of the mobile terminal device 1 can be realized by using a direction in which the mobile terminal device 1 is located with respect to the communication device 2 and distance information between the mobile terminal device 1 and the communication device 2.

The direction in which the mobile terminal device 1 is located with respect to the communication device 2 can be specified by calculating a radio wave arrival angle of wireless communication performed between the mobile terminal device 1 and the communication device 2.

The information processing device M uses phase information in a signal propagation path between the mobile terminal device 1 and the communication device 2 in order to calculate the radio wave arrival angle. This will be specifically described later.

The information processing device M determines whether or not the calculated radio wave arrival angle can be used for positioning, and measures (calculates) the position of the mobile terminal device 1 with respect to the communication device 2 on the basis of the radio wave arrival angle and the distance measurement information in a case where it is determined that the calculated radio wave arrival angle can be used.

In calculating the radio wave arrival angle, it is necessary to transmit a wireless radio wave (measurement signal) from a transmission antenna As of one of the mobile terminal device 1 and the communication device 2 to a reception antenna Ar of the other.

Several combinations of the transmission antenna As and the reception antenna Ar included in the devices can be considered.

For example, the mobile terminal device 1 may include a transmission antenna As1, and the communication device 2 (information processing device M) may include a reception antenna Ar2. Furthermore, the mobile terminal device 1 may include a reception antenna Ar1, and the communication device 2 (information processing device M) may include a transmission antenna As2.

Note that, in the present example, in order to perform distance measurement by a phase based method to be described later, the mobile terminal device 1 includes an antenna that can be used as the transmission antenna As and the reception antenna Ar, and the communication device 2 also includes an antenna that can be used as the transmission antenna As and the reception antenna Ar.

In the example illustrated in FIG. 1, the communication device 2 at least includes the transmission antenna As2, and the mobile terminal device 1 at least includes the reception antenna Ar1.

### <1-2. Hardware Configuration of Information Processing Device>

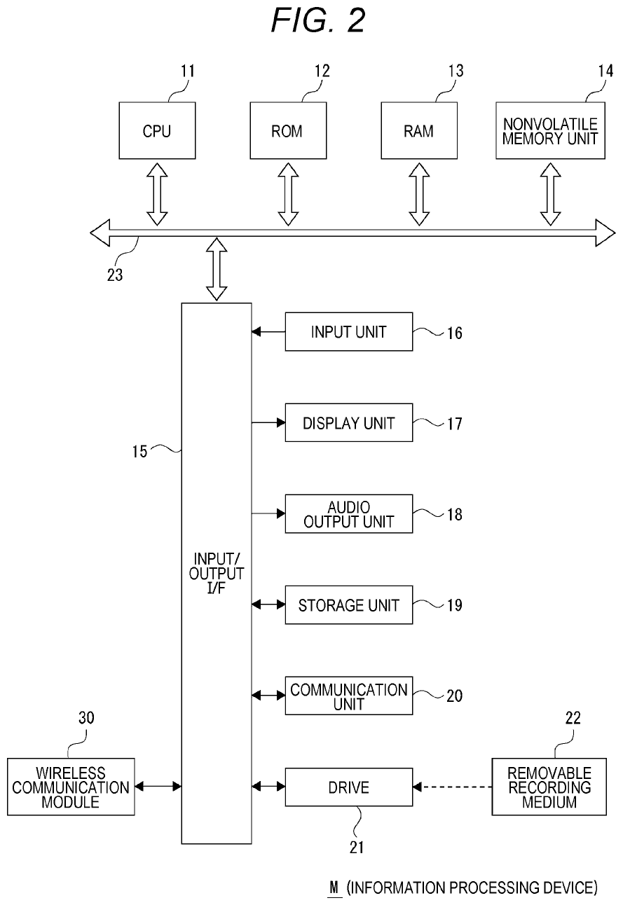

An example of a hardware configuration of the information processing device M (the communication device 2 in the present example) or the mobile terminal device 1 is illustrated in FIG. 2. In the following description, each unit of the information processing device M will be described, but the mobile terminal device 1 has a similar configuration.

As illustrated, the information processing device M (communication device 2) includes a CPU 11. The CPU 11 executes various processes in accordance with a program stored in a ROM 12 or a nonvolatile memory unit 14 such as an electrically erasable programmable read-only memory (EEP-ROM) or the like, or a program loaded from a storage unit 19 to a RAM 13. Furthermore, the RAM 13 appropriately stores data and the like necessary for the CPU 11 to execute various processes.

The program here may include an application program for realizing positioning based on a result of distance measurement by the phase based method, and an application program for realizing various functions using a positioning result such as a navigation function.

The CPU 11, the ROM 12, the RAM 13, and the nonvolatile memory unit 14 are connected to one another via a bus 23. An input/output interface (I/F) 15 is also connected to the bus 23.

An input unit 16 including an operation element or an operation device is connected to the input/output interface 15. For example, as the input unit 16, various types of operation elements and operation devices such as a keyboard, a mouse, a key, a dial, a touch panel, a touch pad, and a remote controller are assumed.

An operation is detected by the input unit 16, and a signal corresponding to the detected operation is interpreted by the CPU 11.

Furthermore, a display unit 17 including a liquid crystal display (LCD), an organic electro-luminescence (EL) panel, or the like, and an audio output unit 18 including a speaker or the like are integrally or separately connected to the input/output interface 15.

The display unit 17 is used for displaying various types of information, and includes, for example, a display device provided in a housing of the information processing device M, a separate display device connected to the information processing device M, or the like.

The display unit 17 displays an image for various types of image processing, a moving image to be processed, or the like, on a display screen on the basis of an instruction from the CPU 11. Furthermore, the display unit 17 displays various operation menus, icons, messages, and the like, that is, performs display as a graphical user interface (GUI), on the basis of an instruction from the CPU 11.

In some cases, the storage unit 19 including a hard disk drive (HDD), a solid-state memory, or the like, and a communication unit 20 including a modem or the like are connected to the input/output interface 15.

The communication unit 20 communicates with an external device via a network line such as the Internet.

Furthermore, a drive 21 is also connected to the input/output interface 15 as necessary, and a removable recording medium 22, such as a magnetic disk, an optical disk, a magneto-optical disk, or a semiconductor memory, is mounted appropriately.

The drive 21 can read a data file such as a program used for each process from the removable recording medium 22. The read data file is stored in the storage unit 19, and an image or audio included in the data file is output by the display unit 17 or the audio output unit 18. Furthermore, a computer program or the like read from the removable recording medium 22 is installed in the storage unit 19 as necessary.

Furthermore, a wireless communication module 30 is connected to the input/output interface 15.

The wireless communication module 30 is a communication module for performing near field communication with an external device. Specifically, the wireless communication module 30 in the mobile terminal device 1 is configured to be able to perform wireless communication by BLE with the communication device 2. Similarly, the wireless communication module 30 in the communication device 2 is configured to be able to perform wireless communication by BLE with the mobile terminal device 1.

Note that, in a case where the information processing device M is provided separately from the mobile terminal device 1 and the communication device 2, it is sufficient that the mobile terminal device 1 and the communication device 2 each include the wireless communication module 30, and the information processing device M does not need to include the wireless communication module 30.

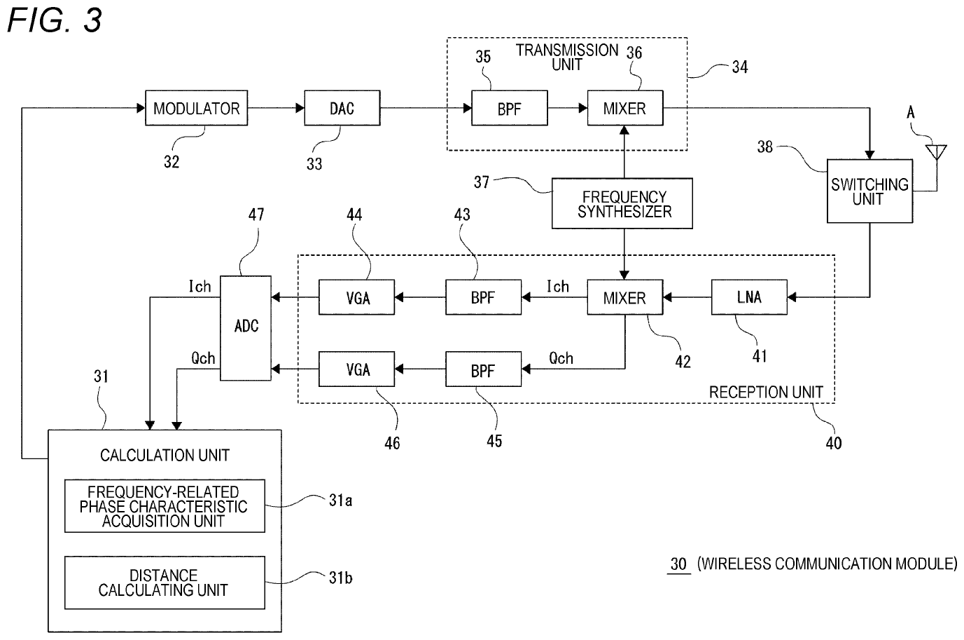

FIG. 3 is a block diagram illustrating an internal configuration example of the wireless communication module 30.

As illustrated, the wireless communication module 30 includes a calculation unit 31, a modulator 32, a digital-to-analog converter (DAC) 33, a transmission unit 34, a frequency synthesizer 37, a switching unit 38, an antenna A, a reception unit 40, and an analog-to-digital converter (ADC) 47.

As described above, the wireless communication module 30 in the present example can perform wireless communication by BLE, but in BLE, it is possible to minimize the time required for an operation requiring large power, such as connection establishment or data communication. Therefore, power consumption can be suppressed, and the wireless communication module 30 can be downsized.

The modulator 32 performs a signal modulation process for performing wireless communication with the communication device 2. Here, as the modulation process, for example, IQ modulation is performed. In the IQ modulation, each of an I channel (In-phase: in-phase component) signal and a Q channel (Quadrature-phase: quadrature component) signal is used as a baseband signal.

The modulator 32 performs the modulation process as the IQ modulation on data to be transmitted supplied from the calculation unit 31.

The DAC 33 converts the digital signal from the modulator 32 into an analog signal. The analog signal converted by the DAC 33 is supplied to the transmission unit 34.

The transmission unit 34 is a block that transmits a signal by wireless communication. As illustrated, the transmission unit 34 includes a band pass filter (BPF) 35 and a mixer 36. The BPF 35 passes only a signal of a specific frequency band. That is, the BPF 35 supplies only a signal of the specific frequency band to the mixer 36 with respect to analog signals from the DAC 33.

The mixer 36 mixes a local oscillation frequency supplied from the frequency synthesizer 37 with the signal supplied from the BPF 35 to convert the signal into a transmission frequency of wireless communication.

The frequency synthesizer 37 supplies a frequency used for transmission and reception. Specifically, the frequency synthesizer 37 includes a local oscillator therein, and is used for conversion of a high-frequency signal and a baseband signal of wireless communication.

The switching unit 38 includes a switch that switches a radio frequency (RF) signal, and the like. The switching unit 38 connects the transmission unit 34 to the antenna A at the time of transmission, and connects the reception unit 40 to the antenna A at the time of reception.

Furthermore, in a case where there is a plurality of antennas A, the switching unit 38 switches the antenna A. That is, at the time of transmission or reception, the switching unit 38 connects the transmission unit 34 or the reception unit 40 to a predetermined antenna A.

The antenna A is an antenna for transmitting and receiving signals by wireless communication. The antenna A is an antenna having a function as the transmission antenna As or the reception antenna Ar described above. In the following description, the antenna A included in the mobile terminal device 1 is referred to as an antenna A1, and the antenna A included in the communication device 2 is referred to as an antenna A2.

The reception unit 40 is a block that receives a signal by wireless communication. As illustrated, the reception unit 40 includes a low noise amplifier (LNA) 41, a mixer 42, a BPF 43, a variable gain amplifier (VGA) 44, a BPF 45, and a VGA 46.

The LNA 41 amplifies the RF signal received by the antenna A. The mixer 42 mixes the signal supplied from the LNA 41 with the local oscillation frequency supplied from the frequency synthesizer 37 to obtain each of an I channel signal and a Q channel signal. The I channel signal (denoted as “Ich” in FIG. 3) is supplied to the BPF 43, and the Q channel signal (denoted as “Qch” in FIG. 3) is supplied to the BPF 45.

The I channel signal obtained by the mixer 42 is input to the BPF 43, and only a signal in a specific frequency band is extracted and supplied to the VGA 44. In contrast, the Q channel signal obtained by the mixer 42 is input to the BPF 45, and only a signal in a specific frequency band is extracted and supplied to the VGA 46.

The VGA 44 and the VGA 46 function as an analog variable gain amplifier that adjusts the gain of the I channel signal supplied from the BPF 43 and an analog variable gain amplifier that adjusts the gain of the Q channel signal supplied from the BPF 45, respectively.

The ADC 47 converts the I channel signal and the Q channel signal from the reception unit 40, that is, the I channel signal and the @ channel signal output via the VGA 44 and the VGA 46 from analog signals to digital signals.

The I channel and Q channel signals converted into the digital signals are supplied to the calculation unit 31.

The calculation unit 31 includes, for example, a microcomputer including a CPU, a ROM, and a RAM, and the CPU executes various processes in accordance with a program stored in the ROM or a program loaded from the ROM into the RAM.

For example, the calculation unit 31 performs a process of supplying data to be transmitted to the modulator 32 and modulating the data. Furthermore, the calculation unit 31 also performs a process of demodulating the received data on the basis of the data of each of the I channel signal and the @ channel signal supplied from the ADC 47, or the like.

Furthermore, the calculation unit 31 has functions as a frequency-related phase characteristic acquisition unit 31a and a distance calculating unit 31b illustrated in FIG. 3 as functions for performing distance measurement using wireless communication.

The frequency-related phase characteristic acquisition unit 31a acquires a phase characteristic with respect to a frequency of the signal propagation path between the mobile terminal device 1 and the communication device 2. In the present example, in order to perform distance measurement by the phase based method as distance measurement using wireless communication, a process of acquiring the phase characteristic with respect to the frequency of the signal propagation path is performed.

The distance calculating unit 31b calculates the distance between the mobile terminal device 1 and the communication device 2 on the basis of the phase characteristic with respect to the frequency of the signal propagation path acquired by the frequency-related phase characteristic acquisition unit 31a.

Note that it is sufficient if the frequency-related phase characteristic acquisition unit 31a and the distance calculating unit 31b is provided in either the mobile terminal device 1 or the communication device 2.

### <1-3. Distance Measurement by Phase Based Method>

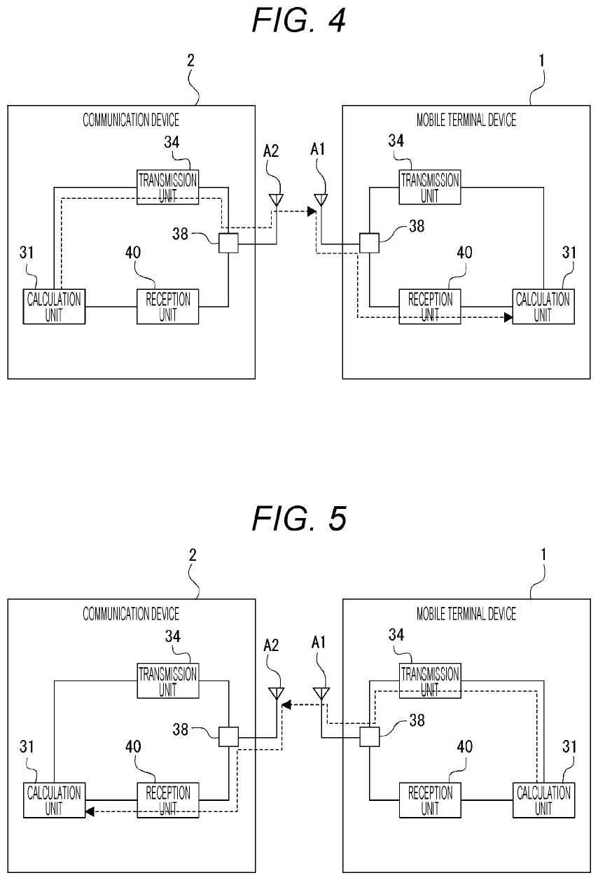

FIGS. 4 and 5 are diagrams illustrating a mode example of phase measurement in the phase based method. In the phase based method, a phase is measured on the basis of a result of performing wireless communication while changing the frequency between two devices having wireless communication functions, that is, between the mobile terminal device 1 and the communication device 2 in the present example.

At this time, first, as illustrated in FIG. 4, a measurement signal is transmitted from the communication device 2 (initiator) to the mobile terminal device 1 (reflector).

Here, the initiator means a device on the side that performs a distance calculation process based on the measured phase, and the reflector means a device which is paired with the initiator and exchanges the measurement signal with the initiator.

Note that FIGS. 4 and 5 mainly illustrate a flow of the measurement signal related to phase measurement, and for example, the modulator 32, the DAC 33, the frequency synthesizer 37, and the ADC 47 are not illustrated.

In FIG. 4, in the communication device 2 as the initiator, the calculation unit 31 transmits the measurement signal from the antenna A2 via the transmission unit 34. Furthermore, in the mobile terminal device 1 as the reflector, the measurement signal is received by the reception unit 40 via the antenna A1.

Then, as illustrated in FIG. 5, a measurement signal is returned from the mobile terminal device 1 to the communication device 2. That is, in the mobile terminal device 1, the calculation unit 31 transmits a measurement signal from the antenna A1 via the transmission unit 34, and in the communication device 2, the measurement signal is received by the reception unit 40 via the antenna A2. Thus, the phase characteristic between the mobile terminal device 1 and the communication device 2 is measured in the calculation unit 31. By performing reciprocating communication in this manner, it is possible to appropriately measure the phase characteristic between the two devices.

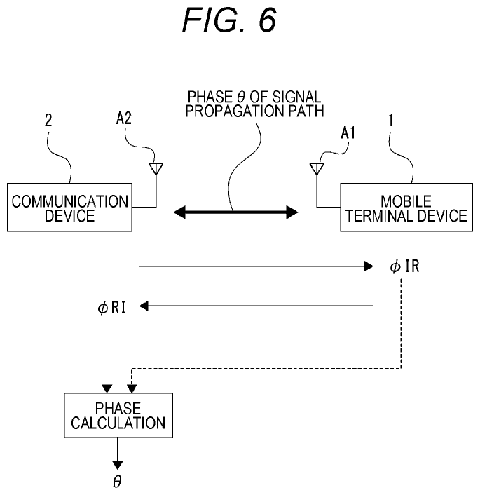

FIG. 6 is an explanatory diagram of a phase θ of the signal propagation path measured in the phase based method.

As illustrated in FIG. 4, in a case where a measurement signal is transmitted from the communication device 2 side to the mobile terminal device 1 side, the mobile terminal device 1 measures the signal phase φ of the measurement signal. Here, the signal phase φ measured when the measurement signal is transmitted from the communication device 2 (initiator) side to the mobile terminal device 1 (reflector) side in this manner is referred to as “φIR”.

Furthermore, as illustrated in FIG. 5, in a case where a measurement signal is transmitted from the mobile terminal device 1 side to the communication device 2 side, the communication device 2 measures the signal phase φ of the measurement signal. The signal phase ¢ measured when the measurement signal is transmitted from the mobile terminal device 1 side to the communication device 2 side in this manner is referred to as “φRI”.

Here, the signal phase q is obtained by the following [Expression 1] when the I channel signal and the Q channel signal obtained by receiving the measurement signal are set as “I” and “Q”, respectively.

$$φ = arctan ( Q / I ) \qquad [ Expression 1 ]$$

Then, in the phase based method, the phase θ of the signal propagation path is obtained on the basis of the signal phase φIR and the signal phase φRI described above. Specifically, the phase θ is obtained by averaging the signal phase φIR and the signal phase oRI. As the averaging calculation here, in addition to the calculation of obtaining the average value of the signal phase φIR and the signal phase φRI, calculation as addition of the signal phase DIR and the signal phase φRI can also be performed.

In the phase based method, the measurement of the phase θ as described above is performed for each frequency while the frequency of the measurement signal is sequentially changed within a predetermined frequency band. In other words, the phase θ is measured for each of the plurality of frequencies. Note that, as the “predetermined frequency band” here, for example, in the case of BLE, it is conceivable to use a frequency band determined as a use band on a communication standard, such as a 2.4 GHz band (band from 2400 MHz to 2480 MHZ).

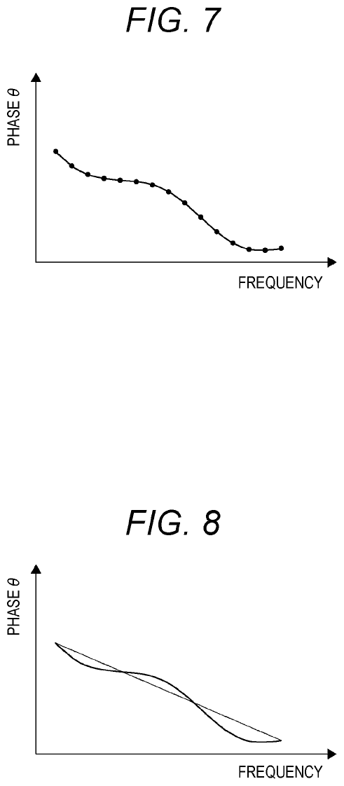

When the phase θ is measured for each frequency within the predetermined frequency band as described above, the measurement result illustrated in FIG. 7 is obtained. A black circle in FIG. 7 indicates a measurement result of the phase θ at each frequency.

The result illustrated in FIG. 7 can be rephrased as a phase characteristic with respect to the frequency of the signal propagation path.

In the phase based method, distance measurement is performed on the basis of a change mode of the phase θ when the frequency changes. Specifically, in the characteristic of the phase θ with respect to a change in frequency, the magnitude of an inclination of the phase θ as illustrated in FIG. 8 correlates with the magnitude of a distance. At this time, the steeper the inclination of the phase θ, the greater the distance. Therefore, the distance can be calculated on the basis of the inclination of the phase θ.

A method of obtaining a group delay t from the inclination of the phase θ and multiplying the group delay τ by the light speed (=299792458 m/s) can be taken as an example of a specific distance calculation method. The group delay τ is used to eliminate the influence of the 2π indefiniteness of the phase. Note that the group delay τ is obtained by differentiating the phase θ with the angular frequency ω.

Here, the method of calculating the distance based on the characteristic of the phase θ with respect to the frequency, that is, the phase characteristic with respect to the frequency of the signal propagation path is not limited to the above method, and various methods can be considered. For example, it is conceivable to employ a method of acquiring not only the characteristic of the phase θ with respect to the frequency but also the characteristic of the amplitude with respect to the frequency, in other words, acquiring not only the frequency characteristic of the phase θ but also the frequency characteristic of the amplitude, converting the frequency characteristics of the phase θ and the amplitude into time response waveforms (impulse response waveforms) by inverse Fourier transform such as inverse fast Fourier transform (IFFT), and obtaining the distance on the basis of the time response waveforms.

Since the phase θ changes according to the frequency, in principle, the distance measurement by the phase based method can be performed by measuring the phase θ for at least two or more frequencies.

As described in FIG. 6, the phase based method is a method of calculating the distance by obtaining the phase θ from measurement results of the signal phases φ in both directions from the communication device 2 to the mobile terminal device 1 and from the mobile terminal device 1 to the communication device 2, and this method, in other words, can be said to be a method of obtaining the distance on the basis of relative difference information of the signal phases φ. Accordingly, the phase based method has an advantage that it is possible to prevent the distance measurement accuracy from deteriorating due to the absolute value of a circuit delay of each block related to signal transmission and reception and a variation value due to the temperature characteristic.

### <1-4. Functional Blocks of Information Processing Device>

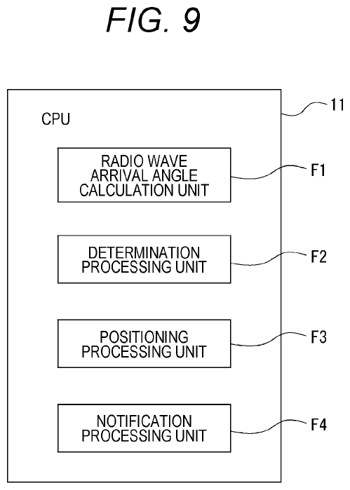

The functional blocks of the information processing device M (the communication device 2 in the present example) will be described with reference to FIG. 9.

The CPU 11 of the information processing device M executes a predetermined program to function as a radio wave arrival angle calculation unit F1, a determination processing unit F2, a positioning processing unit F3, and a notification processing unit F4.

The radio wave arrival angle calculation unit F1 calculates an angle at which the mobile terminal device 1 receives the wireless radio wave (measurement signal) transmitted from the communication device 2, that is, an arrival angle of the radio wave. Note that a radio wave arrival angle obtained when a wireless radio wave transmitted from the mobile terminal device 1 is received by the communication device 2 may be calculated.

Here, a method of calculating a radio wave arrival angle D will be described.

The calculation of the radio wave arrival angle D is realized by using a plurality of transmission antennas As or reception antennas Ar.

For example, the communication device 2 includes four antennas A2a, A2b, A2c, and A2d functioning as the transmission antennas As, and the mobile terminal device 1 includes one antenna A1a functioning as the reception antenna Ar.

Alternatively, the communication device 2 includes one antenna A2a functioning as the transmission antenna As, and the mobile terminal device 1 includes four antennas A1a, Alb, Alc, and Ald functioning as the reception antennas Ar.

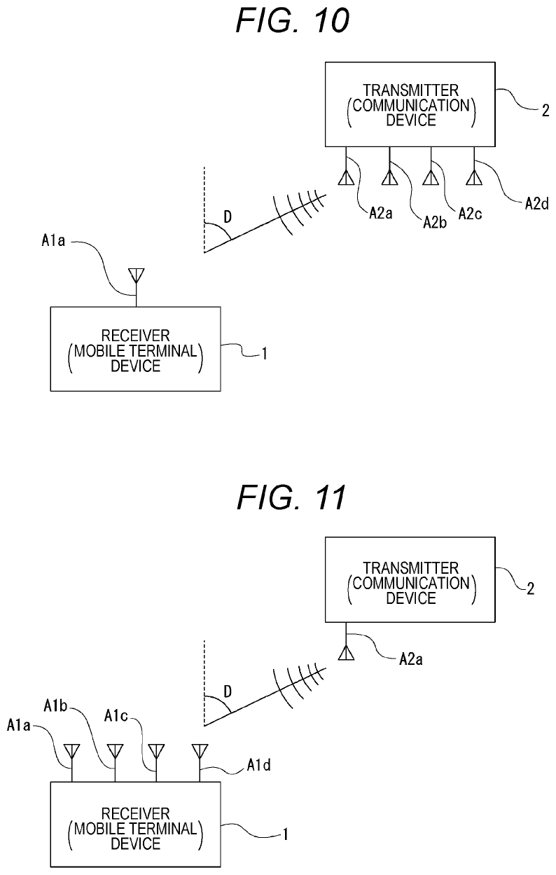

A method of calculating the radio wave arrival angle D with a configuration including a plurality of transmission antennas As is referred to as angle of departure (AoD) (FIG. 10), and a method of calculating the radio wave arrival angle D with a configuration including a plurality of reception antennas Ar is referred to as angle of arrival (AoA) (FIG. 11).

In the following description, AoD will be taken as an example.

In the calculation of the radio wave arrival angle D, it is possible to use the phase θ of the signal propagation path calculated in the distance measurement of the phase based method described above. At this time, it is necessary to calculate the phase θ for each combination of the antennas A that transmit and receive a wireless radio wave.

Specifically, the phase θ of the signal propagation path calculated by transmitting and receiving a wireless radio wave in a set of the antenna A2a, which is one of the four antennas A2 included in the communication device 2, and the one antenna A1a included in the mobile terminal device 1 is obtained.

Next, the phase θ of the signal propagation path is similarly obtained in a set of the antenna A2b, which is one of the four antennas A2 included in the communication device 2, and the one antenna A1a included in the mobile terminal device 1 is obtained. Note that switching from the antenna A2a to the antenna A2b included in the communication device 2 is performed by the switching unit 38 illustrated in FIG. 3. Note that, although one antenna A is schematically illustrated in FIG. 3, four antennas A (A2) are provided in the wireless communication module 30 of the communication device 2 in the present example.

The phase θ is obtained for each of the combination of the antenna A2c and the antenna A1a and the combination of the antenna A2d and the antenna A1a.

Since the length of the signal propagation path is different for each combination of the antennas A, the phase θ differs for each combination of the antennas A.

Then, the difference between the phases θ increases as the radio wave arrival angle D approaches 90 degrees. That is, it means that the radio wave arrival angle D can be calculated from the difference between the phases θ.

The method of calculating the radio wave arrival angle D is standardized by the standardization organization, and thus, will not be described in further detail.

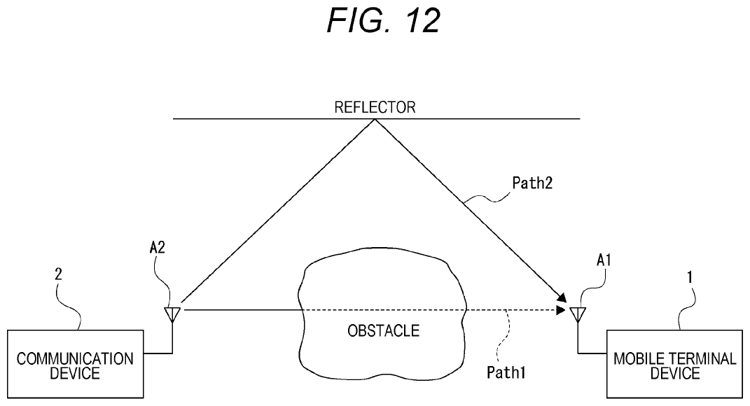

Here, the radio wave arrival angle D decreases in reliability in a multipath environment. This will be specifically described with reference to FIG. 12. A case where an obstacle is present on a straight path between the antenna A1 of the mobile terminal device 1 and the antenna A2 of the communication device 2 will be considered.

In a case where a wireless radio wave is transmitted from the communication device 2 to the mobile terminal device 1, a signal propagation path Path1 through which the radio wave reaches through an obstacle and a signal propagation path Path2 that bypasses the obstacle by a reflector are formed.

In this case, the signal strength at the time of receiving the radio wave propagated through the signal propagation path Path2 is greater than the signal strength at the time of receiving the radio wave propagated through the signal propagation path Path1 in some cases. Due to this difference in signal strength, the radio wave arrival angle D is calculated on the basis of the signal propagation path Path2, and there is a possibility that the direction in which the communication device 2 is located when viewed from the mobile terminal device 1 is wrong.

Therefore, in the present example, the reliability of the radio wave arrival angle D is determined by calculating a plurality of radio wave arrival angles D.

Specifically, the plurality of radio wave arrival angles D is calculated by transmitting and receiving wireless radio waves at different communication frequencies between the mobile terminal device 1 and the communication device 2.

Here, one radio wave arrival angle D calculated on the basis of transmission and reception of a wireless radio wave at a certain frequency is defined as an individual radio wave arrival angle Di.

Then, one radio wave arrival angle D finally calculated (determined) using a plurality of individual radio wave arrival angles Di is set as an integrated radio wave arrival angle Da.

Returning to the description of FIG. 9, the radio wave arrival angle calculation unit F1 calculates a plurality of individual radio wave arrival angles Di for wireless radio waves transmitted and received between the mobile terminal device 1 and the communication device 2 by changing the frequency.

The radio wave arrival angle calculation unit F1 calculates the integrated radio wave arrival angle Da on the basis of the plurality of individual radio wave arrival angles Di. Several methods for calculating the integrated radio wave arrival angle Da can be considered. For example, a histogram of the individual radio wave arrival angles Di may be generated, and the individual radio wave arrival angle Di having a high appearance frequency may be set as the integrated radio wave arrival angle Da, or an average value or a median value of the plurality of individual radio wave arrival angles Di may be set as the integrated radio wave arrival angle Da.

The determination processing unit F2 first determines whether or not the integrated radio wave arrival angle Da is reliable. In other words, it is determined whether or not the integrated radio wave arrival angle Da should be used (or whether or not the integrated radio wave arrival angle Da should be calculated). The determination can be made on the basis of, for example, the plurality of calculated individual radio wave arrival angles Di.

Furthermore, the determination processing unit F2 makes a determination based on the plurality of calculated individual radio wave arrival angles Di as to whether or not the integrated radio wave arrival angle Da can be used for positioning. For example, in a case where the communication device 2 is a stationary device and the mobile terminal device 1 is a device carried by the user, it is conceivable to estimate the relative position of the mobile terminal device 1 with respect to the communication device 2 and execute various processes. Specifically, as will be described later, in the case of estimating the relative position of the mobile terminal device 1 with respect to the communication device 2 in order to execute the various processes, the determination processing unit F2 determines whether the integrated radio wave arrival angle Da can be used.

In a case where the integrated radio wave arrival angle Da has high reliability, the determination processing unit F2 determines that positioning is to be performed using the integrated radio wave arrival angle Da. Note that the integrated radio wave arrival angle Da is not necessarily calculated in order to make the determination. For example, the determination may be made on the basis of the plurality of individual radio wave arrival angles Di, and the radio wave arrival angle calculation unit F1 may calculate the integrated radio wave arrival angle Da for the first time in a case where it is determined that the integrated radio wave arrival angle Da can be used.

Furthermore, the determination processing unit F2 may determine that positioning is to be performed without using the integrated radio wave arrival angle Da in a case where the reliability of the integrated radio wave arrival angle Da is low, may determine that the user is to be notified that the reliability of the integrated radio wave arrival angle Da is low, or may determine that the user is to be notified of instruction information so that the reliability of the integrated radio wave arrival angle Da becomes high. In the present example, it is determined that, for example, a notification for prompting the user to move or change the posture of the mobile terminal device 1 is to be given so that the reliability of the integrated radio wave arrival angle Da increases.

Note that an environment in which the reliability of the integrated radio wave arrival angle Da is low can be said to be an environment in which the evaluation value of the communication quality is low like a multipath environment. That is, it can also be understood that the determination processing unit F2 determines whether or not the radio wave arrival angle D is to be used for positioning on the basis of the communication quality evaluation value.

A method of calculating the communication quality evaluation value will be described later.

The positioning processing unit F3 calculates the relative position of the mobile terminal device 1 with respect to the communication device 2 on the basis of the integrated radio wave arrival angle Da and the distance measurement result of the phase based method.

In a case where the determination processing unit F2 determines that the integrated radio wave arrival angle Da is not to be used for positioning and determines that a notification is to be given to the user, the notification processing unit F4 gives a notification to the user.

The notification processing unit F4 may give the notification by displaying characters, an image, or the like on a display or the like of the mobile terminal device 1 possessed by the user, or may give the notification by performing audio output from the mobile terminal device 1. Furthermore, the notification processing unit F4 may display a notification sentence or an instruction sentence to the user on the screen of a television receiver serving as the communication device 2.

Furthermore, as described above, an instruction to change the posture of the mobile terminal device 1 may be presented to the user as an instruction to more accurately calculate the individual radio wave arrival angle Di or the integrated radio wave arrival angle Da.

### <1-5. Communication Quality Evaluation Value>

Some examples of a method of calculating a communication quality evaluation value will be described.

A first example is a method of calculating the communication quality evaluation value on the basis of the signal phase φIR and the signal phase φRI described above. That is, the communication quality evaluation value can be calculated without calculating the individual radio wave arrival angle Di.

Specifically, the communication quality evaluation value is calculated using the characteristic of the phase θ with respect to the frequency of the signal propagation path calculated by transmitting and receiving the measurement signal by using a combination CB1 of the antenna A1a of the mobile terminal device 1 and the antenna A2a of the communication device 2 and the characteristic of the phase θ with respect to the frequency of the signal propagation path calculated by transmitting and receiving the measurement signal by using a combination CB2 of the antenna A1a of the mobile terminal device 1 and the antenna A2b of the communication device 2.

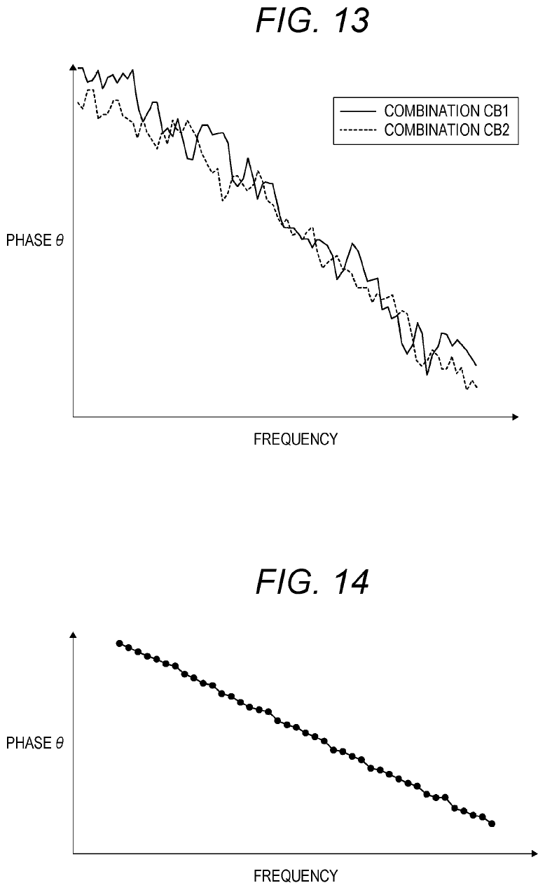

FIG. 13 illustrates a graph of the frequency characteristic of the phase θ for the combination CB1 as a solid line and a graph of the frequency characteristic of the phase θ for the combination CB2 as a broken line.

In a good communication environment in which there is no multipath, as illustrated in FIG. 13, the inclinations of the phase characteristics of the combination CB1 and the combination CB2 are similar to each other.

Therefore, a difference between the inclinations of the phase characteristics of the respective combinations is calculated, and the communication quality evaluation value is calculated so as to be inversely proportional to the difference. That is, the smaller the difference, the higher the communication quality evaluation value is calculated.

A second example is also a method of calculating the communication quality evaluation value on the basis of the signal phase φIR and the signal phase φRI described above.

Specifically, attention is paid to the stability of the inclination of the characteristic of the phase θ with respect to the frequency of the signal propagation path.

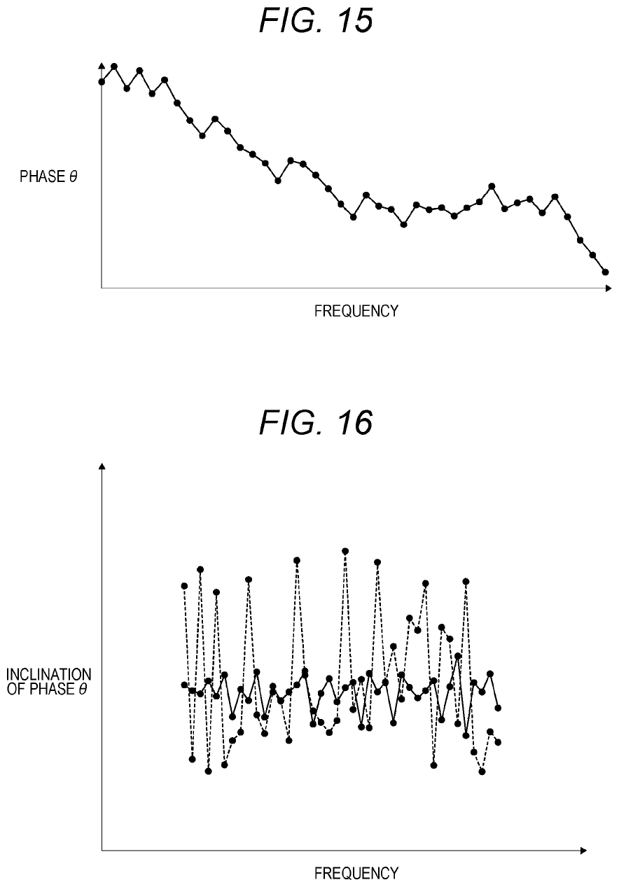

FIG. 14 illustrates a phase characteristic of the signal propagation path acquired in a good communication environment in which there is no multipath. Furthermore, FIG. 15 illustrates a phase characteristic of the signal propagation path acquired in a poor communication environment in which there is multipath.

Note that any combination of the antennas A may be selected.

As illustrated in FIGS. 14 and 15, it can be seen that there is a difference in the stability of the inclination of the phase characteristic.

The inclination of the phase characteristic with respect to the frequency is illustrated in FIG. 16. Note that in FIG. 16, the inclination of the phase characteristic illustrated in FIG. 14 is indicated by a solid line, and the inclination of the phase characteristic illustrated in FIG. 15 is indicated by a broken line.

As illustrated in FIG. 16, the communication quality evaluation value may be calculated to be higher as the variation in the inclination of the phase characteristic is smaller.

A third example is also a method of calculating the communication quality evaluation value on the basis of the signal phase DIR and the signal phase φRI described above.

Specifically, the communication quality evaluation value is calculated on the basis of the time response waveform obtained by performing inverse Fourier transform on the characteristic of the phase θ with respect to the frequency (frequency characteristic of the phase θ) of the signal propagation path calculated on the basis of the signal phase φIR and the signal phase φRI.

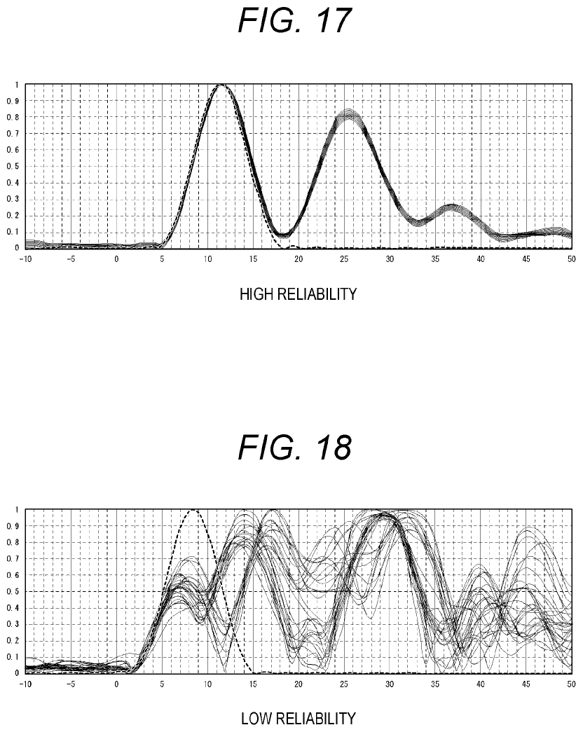

An example of the time response waveform is illustrated in FIGS. 17 and 18.

FIGS. 17 and 18 each illustrate results of converting the frequency characteristic of the phase θ into a time response waveform by performing inverse Fourier transform (for example, IFFT).

FIG. 17 illustrates measurement results in an environment with little influence of multipath, and FIG. 18 illustrates measurement results in an environment with a great influence of multipath. Each of the graphs of the measurement results is obtained by measuring the characteristic of the phase θ with respect to the frequency of the signal propagation path a plurality of times and superimposing time response waveforms obtained by performing inverse Fourier transform on the characteristics of the phase θ. In each of FIGS. 17 and 18, the horizontal axis represents time, the vertical axis represents amplitude, and an ideal one-wave model (ideal model) is indicated by a thick dotted line.

In the environment illustrated in FIG. 17 where the influence of multipath is little, it can be confirmed that the first peak (preceding wave component) is clear, and the ideal model and the waveform shape match. Furthermore, in the plurality of measurement results, there is small variation in the peaks as preceding wave components.

In contrast, in the environment illustrated in FIG. 18 where the influence of multipath is great, the peak as the preceding wave component is unclear as compared with the case of FIG. 17, and furthermore, the variation in the plurality of measurement results is also great.

Such information on the time response waveform can be obtained, which is an advantage peculiar to the phase based method in which the frequency characteristic of the phase θ is acquired by frequency sweep, and is an advantage that cannot be obtained in a case where the conventional distance measuring method using a received signal strength indicator (RSSI) or the like is adopted.

Here, various methods can be considered as a method of calculating the communication quality evaluation value by using the time response waveform based on the frequency characteristic of the phase θ as described above. Basically, it is sufficient if the calculation is performed by obtaining the correlation with the time response waveform as the ideal model illustrated in FIGS. 17 and 18. As an example, a method of obtaining the communication quality evaluation value as the degree of correlation between the preceding wave components regarding the time response waveform obtained by performing the inverse Fourier transform on the actually measured frequency characteristic of the phase θ and the time response waveform as the ideal model can be mentioned. For example, a method of calculating the degree of correlation using a window function for the preceding wave components can be mentioned.

Here, the communication quality evaluation value obtained as the degree of correlation with the time response waveform as the ideal model as described above is the reliability (accuracy) of the distance measurement result by the phase based method.

The communication quality evaluation value (reliability of the distance measurement result) is generally referred to as “signal quality”, “multipath influence degree”, or the like in some cases.

Note that as a method of calculating the communication quality evaluation value by using the time response waveform, a ratio of the amplitude of the first peak, which is the peak as the preceding wave component to the amplitude of the second peak, which is the next peak may be used.

For example, in the measurement result in the environment with little influence of multipath as illustrated in FIG. 17, if the amplitude of the first peak is 1.0, the amplitude of the second peak is about 0.8.

In contrast, in the measurement result in the environment where the influence of the multipath is great as illustrated in FIG. 18, the amplitude of the second peak is greater than the amplitude of the first peak.

In the case of such a difference, that is, in a case where the amplitude of the second peak is smaller than the amplitude of the first peak and the ratio of the first amplitude to the second amplitude is close to 1 to 0.8, the communication quality evaluation value may be calculated to be great.

Furthermore, a communication quality evaluation value that is output data may be obtained from a time response waveform that is input data by using a learning model obtained by machine learning.

Unlike the other examples, a fourth example is not a method of calculating the communication quality evaluation value on the basis of both the signal phase DIR and the signal phase φRI.

Specifically, the individual radio wave arrival angles Di described above are calculated, and the communication quality evaluation value is calculated from the individual radio wave arrival angle Di.

As described above, one individual radio wave arrival angle Di can be calculated on the basis of the phase information obtained for each combination of the antennas A by using one frequency.

Here, in order to calculate the communication quality evaluation value, a plurality of individual radio wave arrival angles Di calculated using a plurality of frequencies is used.

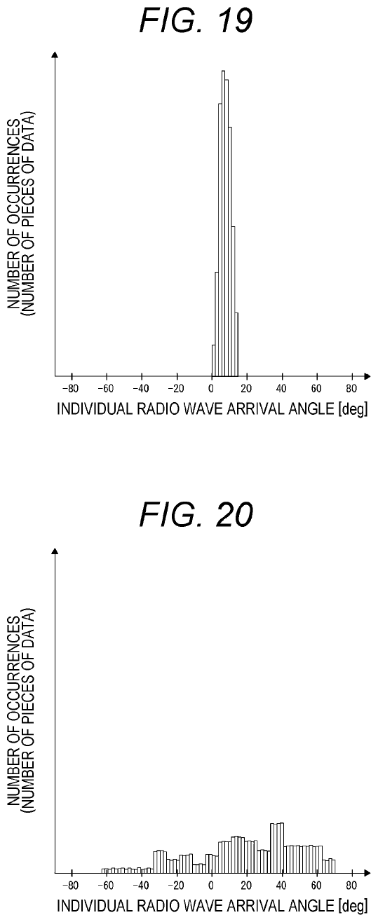

FIG. 19 illustrates a histogram representing the individual radio wave arrival angles Di calculated in an ideal communication environment with little influence of multipath. As illustrated, the calculated individual radio wave arrival angles Di are concentrated in the vicinity of 0 deg to 15 deg, and it can be estimated that the measurement accuracy is high.

FIG. 20 illustrates a histogram representing the individual radio wave arrival angles Di calculated in a communication environment with great influence of multipath. As illustrated, the calculated individual radio wave arrival angles Di are distributed in a wide range from around-60 deg to 70 deg, and it can be estimated that the measurement accuracy is low.

As described above, the communication quality evaluation value can be calculated according to the shape of the histogram, the difference between the minimum value and the maximum value of the individual radio wave arrival angles Di, or the like.

### <1-6. Flow of Processing>

A flow of processing in the case of performing a process of calculating the integrated radio wave arrival angle Da and various processes by using the integrated radio wave arrival angle Da will be described.

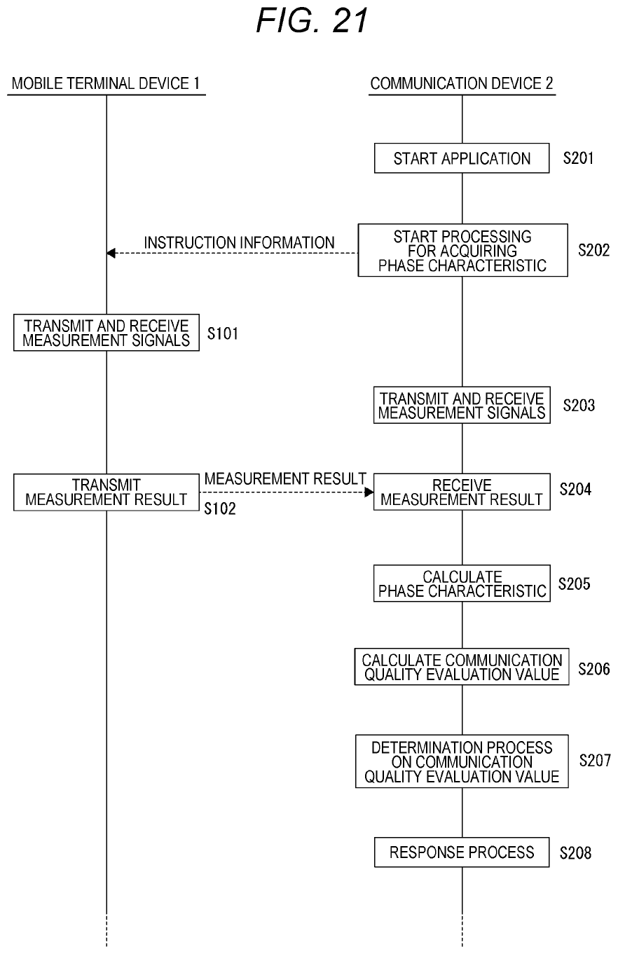

FIG. 21 illustrates a rough flow of the processing executed by the mobile terminal device 1 and the communication device 2.

As illustrated, first, in step S201, the CPU 11 of the communication device 2 starts an application in response to reception of an application start operation. The application is, for example, an application used by the user so that an appropriate sound image is localized for the sound output which is output from a television receiver as the communication device 2, an application for the user located in a shopping mall to receive appropriate information about the surrounding shops, or the like. Note that, in the start processing in step S201, the application may be automatically started regardless of the user's operation.

Subsequently, in step S202, the CPU 11 of the communication device 2 starts processing for acquiring the characteristic of the phase θ with respect to the frequency of the signal propagation path between the antenna A1 of the mobile terminal device 1 and the antenna A2 of the communication device 2.

Specifically, each of the mobile terminal device 1 and the communication device 2 gives an instruction on transmission/reception processing of a measurement signal for acquiring the phase characteristic.

As a result, the CPU 11 of the communication device 2 transmits and receives measurement signals in step S203. Furthermore, on the basis of the instruction, the CPU 11 of the mobile terminal device 1 transmits and receives the measurement signals in step S101.

In step S102, the CPU 11 of the mobile terminal device 1 performs processing of transmitting the measurement result of the phase characteristic to the communication device 2.

In step S204, the CPU 11 of the communication device 2 receives the measurement result from the mobile terminal device 1.

Furthermore, in step S205, the CPU 11 of the communication device 2 calculates the characteristic of the phase θ with respect to the frequency of the signal propagation path by using the measurement result (for example, the signal phase φRI) received from the mobile terminal device 1 and the measurement result (for example, the signal phase qIR) obtained in the communication device 2.

In step S206, the CPU 11 of the communication device 2 calculates a communication quality evaluation value.

As described above, the communication quality evaluation value can be calculated from the signal phase QIR and the signal phase φRI, or the like. In a case where the communication quality evaluation value is calculated from the individual radio wave arrival angles Di, the CPU 11 of the communication device 2 calculates the individual radio wave arrival angles Di before calculating the communication quality evaluation value in step S206.

In step S207, the CPU 11 of the communication device 2 performs a determination process on the communication quality evaluation value. In this determination process, it is determined whether or not there is no problem even if the individual radio wave arrival angles Di are used for positioning.

In step S208, the CPU 11 of the communication device 2 performs a predetermined process as a response process according to the determination result.

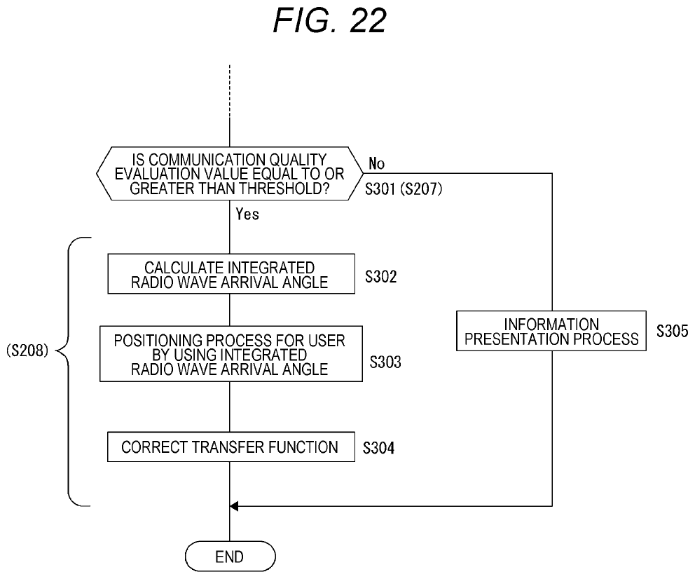

Here, specific examples of the determination process in step S207 and the response process in step S208 will be described with reference to FIG. 22.

In step S301 in FIG. 22, the CPU 11 of the communication device 2 determines whether or not the communication quality evaluation value is equal to or greater than a threshold. This determination process is an example of the processing in step S207.

In a case where it is determined that the communication quality evaluation value is equal to or greater than the threshold, that is, in a case where it is determined that there is no problem if the integrated radio wave arrival angle Da is used for positioning, the CPU 11 of the communication device 2 calculates the integrated radio wave arrival angle Da in step S302. Calculation of the individual radio wave arrival angles Di used to calculate the integrated radio wave arrival angle Da may be performed immediately before the processing in step S302 or may be performed immediately before the determination process in step S301.

In step S303, the CPU 11 of the communication device 2 performs a positioning process for the user by using the integrated radio wave arrival angle Da and distance information. The positioning process for the user is realized by positioning the mobile terminal device 1 possessed by the user.

In step S304, the CPU 11 of the communication device 2 corrects the transfer function for sound output so that the position of the user becomes an appropriate listening position. That is, correction of the transfer function for localizing a predetermined sound image to a predetermined position is performed at the listening position of the user. As a result, appropriate sound output and sound field can be provided to the user.

In contrast, in a case where it is determined in the determination process in step S301 that the communication quality evaluation value is less than the threshold, that is, in a case where it is determined in the determination process in step S301 that there is a problem in accuracy of the positioning result in a case where the integrated radio wave arrival angle Da is used for positioning, the CPU 11 of the communication device 2 performs an information presentation process in step S305.

The information presentation process is, for example, information presentation for changing the posture and position of the mobile terminal device 1 so as to appropriately transmit and receive a measurement signal between the mobile terminal device 1 and the communication device 2, in other words, so as to increase the reliability of the calculated individual radio wave arrival angle Di.

Specifically, the information presentation process is a process of presenting text information or image information for instructing the user to move the posture or position of the mobile terminal device 1 to the user, and the information may be displayed on a display unit included in the mobile terminal device 1 or may be displayed on a screen of a television receiver including the communication device 2.

The process in step S301 illustrated in FIG. 22 is an example of the determination process in step S207 in FIG. 21. Furthermore, the processes in steps S302, S303, and S304 illustrated in FIG. 22 are an example of the response process in step S208 of FIG. 21 in a case where it is determined in the determination process in step S207 that there is no problem if positioning is performed by using the integrated radio wave arrival angle Da. Moreover, the process in step S305 illustrated in FIG. 22 is an example of the response process in step S208 of FIG. 21 in a case where it is determined in the determination process in step S207 that there is a problem in performing positioning by using the integrated radio wave arrival angle Da.

### 2. Second Embodiment

In a second embodiment, in a case where it is determined that there is a problem in accuracy of a positioning result in a case where an integrated radio wave arrival angle Da is used for positioning, positioning is performed without using the integrated radio wave arrival angle Da.

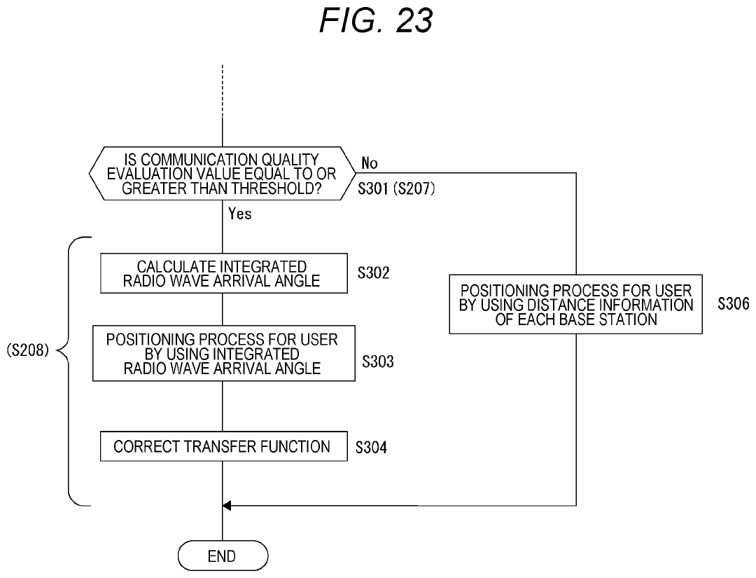

Specifically, an example of processing executed by the CPU 11 of the communication device 2 is illustrated in FIG. 23.

Note that the processes illustrated in FIG. 23 are examples of the specific processes in steps S207 and S208 in FIG. 21.

Note that, since the processes in steps S301 to S304 are similar to the processes in FIG. 22, the description thereof is omitted.

In a case where it is determined in the determination process in step S301 that the communication quality evaluation value is less than the threshold, that is, in a case where it is determined in the determination process in step S301 that there is a problem in accuracy of the positioning result in a case where the integrated radio wave arrival angle Da is used for positioning, the CPU 11 of the communication device 2 performs positioning of the user without using the integrated radio wave arrival angle Da in step S306.

Here, positioning of the user performed without using the integrated radio wave arrival angle Da will be described.

For example, an example in which the user is located in a space such as a shopping mall, where a plurality of communication devices 2 functioning as BLE beacons is present will be described.

Note that, in the above-described example, calculation of the individual radio wave arrival angles Di and the integrated radio wave arrival angle Da and the positioning process of the user are performed in the communication device 2. However, in the present example, calculation of the individual radio wave arrival angles Di and the integrated radio wave arrival angle Da and the positioning process of the user are performed in the mobile terminal device 1 such as a smartphone possessed by the user.

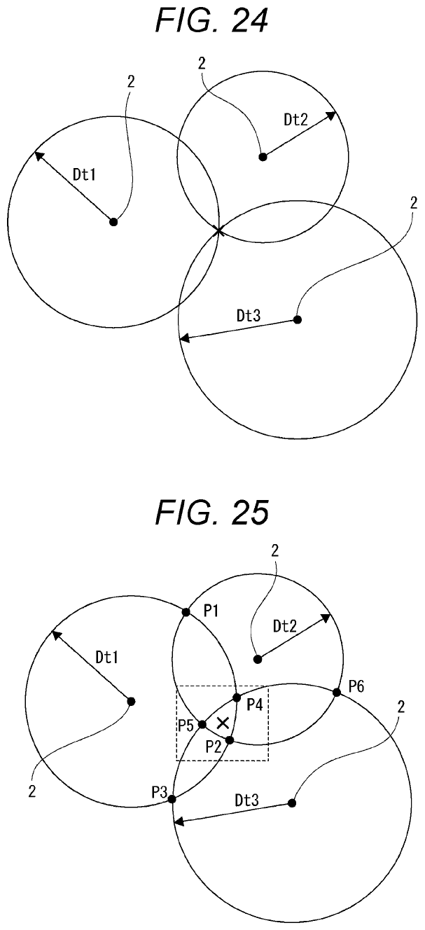

The mobile terminal device 1 can specify the position of the mobile terminal device 1 by three-point positioning if the mobile terminal device 1 can measure the distance to each of at least three communication devices 2 and can specify the distance Dt to each of the three communication devices 2. Specifically, since the arrangement position of each of the communication devices 2 as beacons is known, as illustrated in FIG. 24, the position of the mobile terminal device 1 can be obtained as an intersection (a cross in FIG. 24) of three circles each centered on the position of the communication device 2 and having the distance Dt (Dt1 to Dt3 in FIG. 24) to the communication device 2 as a radius.

However, in practice, three circles rarely intersect at one point. That is, even if circles intersect, a plurality of intersections P usually exists. FIG. 25 illustrates a state in which three circles do not intersect at one point, and a total of six intersections P1, P2, P3, P4, P5, and P6 are generated by the three circles. In this case, the position of the positioning target device (that is, the mobile terminal device 1) can be calculated on the basis of the area formed by these intersections P. Specifically, a method can be mentioned in which three points that can be selected from the six intersections P, the three points minimizing the area of the triangle formed by connecting the points, in other words, three intersections P (three points, that is, the intersections P2, P4, and P5 in the example of FIG. 25) that form a portion where the three circles overlap one another are specified, and the barycentric position of the triangle formed by the three points is obtained as the position of the positioning target device.

Note that a positioning calculation method for specifying the position of the positioning target device by using the distance Dt to each of the plurality of communication devices 2 is not limited to the positioning calculation method by the centroid method as described above, and various methods can be considered, and is not limited to a specific method.

As described above, positioning of the user position can be realized without using the integrated radio wave arrival angle Da. Then, by determining whether or not the integrated radio wave arrival angle Da can be used for positioning, the position of the user can be measured using an appropriate positioning method.

### 3. Modifications

In the calculation of the radio wave arrival angle described above, the characteristic of the phase θ calculated using the phase based method, that is, the characteristic of the phase θ with respect to the frequency of the signal propagation path is used on the basis of the signal phase φIR and the signal phase PRI obtained by transmission and reception of the measurement signal. However, only one of the signal phase φIR and the signal phase φRI may be used.

For example, the radio wave arrival angle D may be calculated by regarding the signal phase φIR obtained by transmitting the measurement signal from the communication device 2 as the initiator to the mobile terminal device 1 as the reflector, as the phase θ described above. Of course, the radio wave arrival angle D may be calculated by regarding the signal phase φRI as the phase θ described above.

As a result, it is not necessary to bidirectionally transmit and receive measurement signals in order to calculate the radio wave arrival angle D, and the radio wave arrival angle D can be easily calculated.

Furthermore, in the above-described example, it has been described that the communication quality evaluation value is used to determine whether or not it is appropriate to use the individual radio wave arrival angles Di for positioning. Furthermore, it has been described that the calculation of the communication quality evaluation value may be based on the degree of correlation with the time response waveform as the ideal model.

In this case, the communication quality evaluation value may be simply calculated by comparing one time response waveform obtained from one frequency with the ideal model instead of comparing each of time response waveforms obtained for a plurality of frequencies with the ideal model.

As a result, it is possible to reduce the time and calculation amount related to the calculation of the communication quality evaluation value.

In the above-described example, execution of the various processes for executing positioning of the user in the communication device 2 as the information processing device M has been described. That is, in the above-described example, in order to calculate the characteristic of the phase θ with respect to the frequency of the signal propagation path, the communication device 2 executes the process of transmitting a command for causing the mobile terminal device 1 to transmit and receive measurement signals to the mobile terminal device 1, the process of acquiring the acquired signal phase φIR and signal phase φRI and calculating the frequency characteristic of the phase 9, the process of calculating the individual radio wave arrival angles Di and the integrated radio wave arrival angle Da, the process of determining whether or not the radio wave arrival angle D can be used for positioning, and the process of performing positioning of the user by using the integrated radio wave arrival angle Da.

However, the devices to be the execution subjects of the respective processes may be other combinations. For example, the mobile terminal device 1 as the information processing device M possessed by the user may transmit a command for causing the communication device 2 to transmit and receive measurement signals to the communication device 2. Then, the process of calculating the frequency characteristic of the phase θ on the basis of the signal phase φIR and the signal phase φRI obtained by transmission and reception of the measurement signals may be performed by the mobile terminal device 1, may be performed by the communication device 2, or may be performed by a server device other than the mobile terminal device 1 and the communication device 2, or the like.

Furthermore, the process of calculating the individual radio wave arrival angles Di and the integrated radio wave arrival angle Da on the basis of the frequency characteristic of the phase θ, the process of determining whether or not the radio wave arrival angle D can be used for positioning, and the process of performing positioning of the user by using the integrated radio wave arrival angle Da may also be executed in any of the mobile terminal device 1, the communication device 2, and a server device other than the mobile terminal device 1 and the communication device 2.

### 4. SUMMARY

As described in each of the examples described above, the information processing device M (the communication device 2 or the mobile terminal device 1) includes the determination processing unit F2 which makes a use determination on the radio wave arrival angle D on the basis of a plurality of pieces of phase information, each of the plurality of phase information being phase information of the signal propagation path for each set of the transmission antenna As (As1, As2) and the reception antenna Ar (Ar1, Ar2), and being calculated for a corresponding frequency of a wireless signal propagated through the signal propagation path.

The radio wave arrival angle D is erroneously detected in some cases depending on an environment in which the wireless signal is transmitted and received. According to the present configuration, it is possible to determine whether or not to use the radio wave arrival angle D in the first place on the basis of the phase information of the signal propagation path. Therefore, it is possible to determine whether or not the radio wave arrival angle D should be used for positioning.

As a result, it is possible to reduce the likelihood that positioning with a large error will be performed by using the radio wave arrival angle D calculated erroneously.

Note that the use determination on a radio wave arrival angle D performed by the determination processing unit F2 may determine whether or not to use a radio wave arrival angle D after calculating the radio wave arrival angle D, or may determine whether or not to use a radio wave arrival angle D before calculating the radio wave arrival angle D.

Note that in a case where it is determined whether or not to use a radio wave arrival angle D before calculating the radio wave arrival angle D, calculation of a radio wave arrival angle D is not performed when it is determined that the radio wave arrival angle D is not used. This is synonymous with determining whether or not to calculate the radio wave arrival angle D.

As described with reference to FIG. 10 and the like, the set of the transmission antenna As (As1, As2) and the reception antenna Ar (Ar1, Ar2) may be a set of a plurality of transmission antennas As and one reception antenna Ar.

Calculation of the radio wave arrival angle D can be realized by preparing a plurality of transmission antennas As or reception antennas Ar. According to this configuration, by transmitting wireless signals to the reception antenna Ar by using the plurality of transmission antennas As, it is possible to detect each of the phases of the wireless signals received by the reception antenna Ar and calculate the radio wave arrival angle D.

As described with reference to FIG. 11 and the like, the set of the transmission antenna As (As1, As2) and the reception antenna Ar (Art, Ar2) may be a set of one transmission antenna As and a plurality of reception antennas Ar.

According to the present configuration, by transmitting a wireless signal (measurement signal) by using the plurality of reception antennas Ar for the transmission antenna As, it is possible to detect the phase of the wireless signal received by each of the reception antennas Ar and calculate the radio wave arrival angle D.

As described above, the determination processing unit F2 of the information processing device M (the communication device 2 or the mobile terminal device 1) may makes a use determination on the basis of the communication quality evaluation value for the signal propagation path calculated on the basis of phase information.

The communication evaluation value for the signal propagation path has a low score in a multipath environment or the like in which a radio wave is likely to be reflected by an obstacle or the like. Therefore, by calculating the communication evaluation value, it is possible to estimate the reliability of the calculated radio wave arrival angle D, and it is possible to appropriately determine whether or not to use the calculated radio wave arrival angle D for positioning.

As described with reference to each of FIGS. 13 to 18, the communication quality evaluation value may be calculated on the basis of first phase information (signal phase qIR) that is phase information obtained on the basis of the received signal of the wireless signal (measurement signal) transmitted from a first apparatus (initiator) including the transmission antenna As (As1, As2) to a second apparatus (reflector) including the reception antenna Ar (Ar1, Ar2) and second phase information (signal phase RI) that is phase information obtained on the basis of the received signal of the wireless signal transmitted from the second apparatus (reflector) to the first apparatus (initiator).

That is, since the phase characteristic with respect to the frequency of the signal propagation path is measured by reciprocating wireless signals between the first apparatus and the second apparatus, it is possible to eliminate a variation factor due to a circuit delay or a temperature characteristic of each block related to transmission and reception of the wireless signal. That is, since the phase characteristic with respect to the frequency of the signal propagation path can be measured with high accuracy, the communication quality evaluation value can be appropriately calculated.

As described with reference to each of FIGS. 14 to 16, the communication quality evaluation value may be calculated on the basis of the variation in the phase characteristic with respect to the frequency of the signal propagation path.

The phase characteristic with respect to the frequency of the signal propagation path fluctuates more in a multipath environment than in a good communication environment. Therefore, the communication quality evaluation value can be appropriately calculated by calculating the variation of the phase characteristic.

As described with reference to FIG. 13 and the like, the communication quality evaluation value may be calculated on the basis of the difference in inclination of the phase characteristic with respect to the frequency of the signal propagation path for each set.

Regarding the phase characteristic with respect to the frequency of the signal propagation path, even if the transmission antenna As or the reception antenna Ar is different, the change in the phase with respect to the change in the frequency is similar in a communication environment where the influence of multipath is little. This is because the plurality of transmission antennas As or the plurality of reception antennas Ar is arranged close to each other.

Therefore, the difference in the inclination of the phase characteristic measured for each set of the transmission antenna As and the reception antenna Ar becomes smaller in a better communication environment.

By using the difference in the inclination of the phase characteristic with respect to the frequency of the signal propagation path, it is possible to appropriately calculate the communication quality evaluation value.

As described with reference to FIGS. 17, 18, and the like, the communication quality evaluation value may be calculated on the basis of the time response waveform (impulse response waveform) obtained from the phase characteristic with respect to the frequency of the signal propagation path.

For example, it is possible to appropriately calculate the communication quality evaluation value according to how much the shape of the time response waveform matches the ideal waveform shape.

In the comparison of the shape of the time response waveform, for example, a ratio of the amplitude of the first peak to the amplitude of the second peak may be compared, or the waveform shapes of the first peaks may be compared. Alternatively, the communication quality evaluation value may be calculated by inputting waveform data acquired this time to a learning model obtained by learning past data by machine learning. Furthermore, output from the learning model may be a 100 step communication quality evaluation value, or may be a binary value indicating whether or not the communication quality evaluation value should be used for positioning.

As described with reference to FIGS. 19, 20 and the like, the communication quality evaluation value is calculated on the basis of a plurality of individual radio wave arrival angles Di obtained for frequencies of wireless signals, respectively, and the determination processing unit F2 of the information processing device M (the communication device 2 or the mobile terminal device 1) may makes a determination as to whether or not to use the integrated radio wave arrival angle Da representing the plurality of individual radio wave arrival angles Di on the basis of the communication quality evaluation value, as the use determination.

One piece of phase information regarding the signal propagation path can be measured by a plurality of sets of wireless communication using the transmission antenna As and the reception antenna Ar, and one radio wave arrival angle D can be calculated from the one piece of phase information. Assuming that the radio wave arrival angle D is an “individual radio wave arrival angle Di”, it is possible to measure a plurality of pieces of phase information regarding the signal propagation path by changing the frequency used for the wireless communication, thereby the plurality of individual radio wave arrival angles Di can be calculated.

In an environment where the influence of multipath is strong, the variation in the individual radio wave arrival angle Di for each communication frequency increases, and in an ideal environment, the variation in the individual radio wave arrival angle Di decreases.

Therefore, it is possible to calculate an appropriate communication quality evaluation value on the basis of the individual radio wave arrival angles Di.

As described with reference to FIGS. 19, 20, and the like, the communication quality evaluation value may be calculated on the basis of the histogram of the individual radio wave arrival angles Di.

A histogram of the individual radio wave arrival angle Di for each communication frequency is created, and the communication quality evaluation value can be appropriately calculated on the basis of the degree of variation.

As described with reference to FIG. 9 and the like, the determination processing unit F2 of the information processing device M (the communication device 2 or the mobile terminal device 1) may make a determination as to whether or not to execute positioning based on the integrated radio wave arrival angle Da, as the use determination.

By appropriately determining whether or not to use the radio wave arrival angle D for positioning, it is possible to reduce the likelihood that positioning with a large error will be performed by using the radio wave arrival angle D calculated erroneously.

As described with reference to FIGS. 21, 22 and the like, the determination processing unit F2 of the information processing device M (the communication device 2 or the mobile terminal device 1) may decide to execute a predetermined process in a case where the determination processing unit F2 determines that positioning based on the integrated radio wave arrival angle Da is to be executed.

As a result, in a case where it is determined that highly accurate positioning can be performed on the basis of the integrated radio wave arrival angle Da, the predetermined process using the positioning information can be executed. The predetermined process may be, for example, the process of presenting information to the user according to highly accurate positioning information.

As described with reference to FIGS. 21, 22 and the like, the predetermined process may be a process of constructing a sound field on the basis of position information specified by positioning.

In a case where the listening position of the user can be appropriately measured, the sound image can be localized at an appropriate position according to the positioning information. Therefore, appropriate sound can be provided to the user.

As described with reference to FIGS. 9, 21 and the like, the determination processing unit F2 of the information processing device M (the communication device 2 or the mobile terminal device 1) may decide to perform information presentation to the user in a case where the determination processing unit F2 determines that positioning based on the integrated radio wave arrival angle Da is not to be executed.

The information presentation to the user may be, for example, a notification indicating that the influence of multipath is great and positioning cannot be appropriately performed, or may be a suggestion of an action for reducing the influence of multipath.

As described with reference to FIGS. 9, 21, and the like, the information presentation may be information including an instruction to change the posture of a mobile device (mobile terminal device 1 such as a smartphone) possessed by the user.

Therefore, it is possible to improve a reception environment or a transmission environment of the mobile device such as a smartphone or a remote controller, to calculate the radio wave arrival angle D with high accuracy, and to perform positioning with high accuracy.

As described with reference to FIGS. 23 to 25 in the second embodiment, the determination processing unit F2 of the information processing device M (the communication device 2 or the mobile terminal device 1) may decide to perform positioning not on the basis of the integrated radio wave arrival angle Da in a case where the determination processing unit F2 determines that positioning is not to be executed on the basis of the integrated radio wave arrival angle Da.

The positioning performed not on the basis of the integrated radio wave arrival angle Da is, for example, a method (three-point positioning) of performing positioning on the basis of distance information with a plurality of base stations (transmission base stations or reception base stations, and for example, communication devices 2 that are BLE base stations).

Therefore, it is possible to perform positioning with high accuracy even in a case where the accuracy of the integrated radio wave arrival angle Da is low.

As described above, the information processing device M (the communication device 2 or the mobile terminal device 1) may include the transmission antenna As (As1, As2).

That is, the information processing device M as a transmitter can appropriately determine whether or not to use the calculated radio wave arrival angle D for positioning according to whether or not the calculated radio wave arrival angle D is appropriate.

As described above, the information processing device M (the communication device 2 or the mobile terminal device 1) may include the reception antenna Ar (Ar1, Ar2).

That is, the information processing device M as a receiver can appropriately determine whether or not to use the calculated radio wave arrival angle D for positioning according to whether or not the calculated radio wave arrival angle D is appropriate.

Furthermore, an information processing method as an embodiment is an information processing method including, by an arithmetic processing device, making a use determination on the radio wave arrival angle D on the basis of a plurality of pieces of phase information, each of the plurality of phase information being phase information of the signal propagation path for each set of the transmission antenna As (As1, As2) and the reception antenna Ar (Ar1, Ar2), and being calculated for a corresponding frequency of a wireless signal propagated through the signal propagation path.

Such an information processing method can produce functions and effects similar to the functions and effects produced by the information processing device as the embodiment described above.

As described in each of the examples described above, a program may be considered, for example, for causing a CPU, a digital signal processor (DSP), or the like, or a device including the CPU, the DSP, or the like, to execute the processing executed by the communication device 2 described in FIGS. 21, 22, 23 and the like.

That is, the program according to an embodiment is a program readable by a computer device, the program causing the computer device to realize a function of making a determination as to whether or not to execute positioning using the radio wave arrival angle D on the basis of a plurality of pieces of phase information, each of the plurality of pieces of phase information being phase information of a signal propagation path for each set of the transmission antenna As (As1, As2) and the reception antenna Ar (Ar1, Ar2), and being calculated for a corresponding frequency of a wireless signal propagated through the signal propagation path.

With such a program, the function as the determination processing unit F2 described above can be implemented in an apparatus as the information processing device M (the mobile terminal device 1 or the communication device 2).

The program described above can be recorded in advance in an HDD as a recording medium built in an apparatus such as a computer device, a ROM in a microcomputer having a CPU, or the like.

Alternatively, the program can be temporarily or permanently stored (recorded) in a removable recording medium such as a flexible disk, a compact disc read only memory (CD-ROM), a magneto optical (MO) disk, a digital versatile disc (DVD), a Blu-ray disc (registered trademark), a magnetic disk, a semiconductor memory, or a memory card. Such a removable recording medium can be provided as so-called package software.

Furthermore, such a program can be installed from the removable recording medium into a personal computer or the like, or may be downloaded from a downloading site over a network such as a local area network (LAN) or the Internet.

Furthermore, such a program is suitable for providing the determination processing unit F2 according to the embodiment in a wide range. For example, by downloading the program to a personal computer, a mobile information processing device, a mobile phone, a game device, a video device, a personal digital assistant (PDA), or the like, the personal computer or the like can be caused to function as a device that realizes the processing as the determination processing unit F2 according to the present disclosure.

Note that the effects described in the present specification are merely examples and are not restrictive, and other effects may be exerted.

Furthermore, the above-described examples may be combined in any way, and the above-described various functions and effects may be obtained even in a case where various combinations are used.

### 5. Present Technology

Note that the present technology can also adopt the following configurations.

(1)

An information processing device including a determination processing unit which performs use determination on a radio wave arrival angle on the basis of a plurality of pieces of phase information, each of the plurality of pieces of phase information being phase information of a signal propagation path for each set of a transmission antenna and a reception antenna, and being calculated for a corresponding frequency of a wireless signal propagated through the signal propagation path.

(2)

The information processing device according to (1), in which the set of the transmission antenna and the reception antenna is a set of a plurality of the transmission antennas and one of the reception antenna.

(3)

The information processing device according to (1), in which the set of the transmission antenna and the reception antenna is a set of one of the transmission antenna and a plurality of the reception antennas.

(4)

The information processing device according to any one of (1) to (3), in which the determination processing unit makes the use determination on the basis of a communication quality evaluation value for the signal propagation path calculated on the basis of the phase information.

(5)

The information processing device according to (4), in which the communication quality evaluation value is calculated on the basis of first phase information that is the phase information obtained on the basis of a received signal of a wireless signal transmitted from a first apparatus having the transmission antenna to a second apparatus having the reception antenna, and second phase information that is the phase information obtained on the basis of a received signal of a wireless signal transmitted from the second apparatus to the first apparatus.

(6)

The information processing device according to any one of (4) to (5), in which the communication quality evaluation value is calculated on the basis of a variation in a phase characteristic with respect to a frequency of the signal propagation path.

(7)

The information processing device according to any one of (4) to (5), in which the communication quality evaluation value is calculated on the basis of a difference in an inclination of a phase characteristic with respect to a frequency of the signal propagation path for the each set.

(8)

The information processing device according to any one of (4) to (5), in which the communication quality evaluation value is calculated on the basis of a time response waveform obtained from a phase characteristic with respect to a frequency of the signal propagation path.

(9)

The information processing device according to (4), in which
the communication quality evaluation value is calculated on the basis of a plurality of individual radio wave arrival angles obtained for frequencies of wireless signals, respectively, and
the determination processing unit makes a determination as to whether or not to use an integrated radio wave arrival angle representing the plurality of individual radio wave arrival angles on the basis of the communication quality evaluation value, as the use determination.
   (10)

The information processing device according to (9), in which the communication quality evaluation value is calculated on the basis of a histogram of the plurality of individual radio wave arrival angles.

(11)

The information processing device according to any one of (9) to (10), in which the determination processing unit makes a determination as to whether or not to execute positioning based on the integrated radio wave arrival angle, as the use determination.

(12)

The information processing device according to (11), in which the determination processing unit decides to execute a predetermined process in a case where the determination processing unit determines that the positioning based on the integrated radio wave arrival angle is to be executed.

(13)

The information processing device according to (12), in which the predetermined process is a process for constructing a sound field on the basis of position information specified by the positioning.

(14)

The information processing device according to any one of (11) to (13), in which the determination processing unit decides to perform information presentation to a user in a case where the determination processing unit determines that the positioning based on the integrated radio wave arrival angle is not to be executed.

(15)

The information processing device according to (14), in which the information presentation is information including an instruction to change a posture of a mobile device possessed by the user.

(16)

The information processing device according to any one of (11) to (13), in which the determination processing unit decides to perform positioning not on the basis of the integrated radio wave arrival angle in a case where the determination processing unit determines that the positioning based on the integrated radio wave arrival angle is not to be executed.

(17)

The information processing device according to any one of (1) to (16) further including the transmission antenna.

(18)

The information processing device according to any one of (1) to (16) further including the reception antenna.

(19)

An information processing method including by an arithmetic processing device, making a use determination on a radio wave arrival angle on the basis of a plurality of pieces of phase information, each of the plurality of pieces of phase information being phase information of a signal propagation path for each set of a transmission antenna and a reception antenna, and being calculated for a corresponding frequency of a wireless signal propagated through the signal propagation path.

(20)

A program readable by a computer device, the program causing the computer device to realize a function of making a use determination on a radio wave arrival angle on the basis of a plurality of pieces of phase information, each of the plurality of pieces of phase information being phase information of a signal propagation path for each set of a transmission antenna and a reception antenna, and being calculated for a corresponding frequency of a wireless signal propagated through the signal propagation path.

### REFERENCE SIGNS LIST

| | |
|---|---|
| S | Positioning system |
| 1 | Mobile terminal device (First apparatus, Second |
| | apparatus, Mobile device) |
| 2 | Communication device (First apparatus, Second |
| | apparatus) |
| M | Information processing device |
| As, As1, As2 | Transmission antenna |
| Ar, Ar1, Ar2 | Reception antenna |
| F2 | Determination processing unit |
| D | Radio wave arrival angle |
| Di | Individual radio wave arrival angle |
| Da | Integrated radio wave arrival angle |
| Path1, Path2 | Signal propagation path |

1. An information processing device comprising a determination processing unit which makes a use determination on a radio wave arrival angle on a basis of a plurality of pieces of phase information, each of the plurality of pieces of phase information being phase information of a signal propagation path for each set of a transmission antenna and a reception antenna, and being calculated for a corresponding frequency of a wireless signal propagated through the signal propagation path.

2. The information processing device according to claim 1, wherein the set of the transmission antenna and the reception antenna is a set of a plurality of the transmission antennas and one of the reception antenna.

3. The information processing device according to claim 1, wherein the set of the transmission antenna and the reception antenna is a set of one of the transmission antenna and a plurality of the reception antennas.

4. The information processing device according to claim 1, wherein the determination processing unit makes the use determination on a basis of a communication quality evaluation value for the signal propagation path calculated on a basis of the phase information.

5. The information processing device according to claim 4, wherein the communication quality evaluation value is calculated on a basis of first phase information that is the phase information obtained on a basis of a received signal of a wireless signal transmitted from a first apparatus having the transmission antenna to a second apparatus having the reception antenna, and second phase information that is the phase information obtained on a basis of a reception signal of a wireless signal transmitted from the second apparatus to the first apparatus.

6. The information processing device according to claim 4, wherein the communication quality evaluation value is calculated on a basis of a variation in a phase characteristic with respect to a frequency of the signal propagation path.

7. The information processing device according to claim 4, wherein the communication quality evaluation value is calculated on a basis of a difference in an inclination of a phase characteristic with respect to a frequency of the signal propagation path for the each set.

8. The information processing device according to claim 4, wherein the communication quality evaluation value is calculated on a basis of a time response waveform obtained from a phase characteristic with respect to a frequency of the signal propagation path.

9. The information processing device according to claim 4, wherein
the communication quality evaluation value is calculated on a basis of a plurality of individual radio wave arrival angles obtained for frequencies of wireless signals, respectively, and
the determination processing unit makes a determination as to whether or not to use an integrated radio wave arrival angle representing the plurality of individual radio wave arrival angles on a basis of the communication quality evaluation value, as the use determination.

10. The information processing device according to claim 9, wherein the communication quality evaluation value is calculated on a basis of a histogram of the plurality of individual radio wave arrival angles.

11. The information processing device according to claim 9, wherein the determination processing unit makes a determination as to whether or not to execute positioning based on the integrated radio wave arrival angle, as the use determination.

12. The information processing device according to claim 11, wherein the determination processing unit decides to execute a predetermined process in a case where the determination processing unit determines that the positioning based on the integrated radio wave arrival angle is to be executed.

13. The information processing device according to claim 12, wherein the predetermined process is a process for constructing a sound field on a basis of position information specified by the positioning.

14. The information processing device according to claim 11, wherein the determination processing unit decides to perform information presentation to a user in a case where the determination processing unit determines that the positioning based on the integrated radio wave arrival angle is not to be executed.

15. The information processing device according to claim 14, wherein the information presentation is information including an instruction to change a posture of a mobile device possessed by the user.

16. The information processing device according to claim 11, wherein the determination processing unit decides to perform positioning not on a basis of the integrated radio wave arrival angle in a case where the determination processing unit determines that the positioning based on the integrated radio wave arrival angle is not to be executed.

17. The information processing device according to claim 1 further comprising the transmission antenna.

18. The information processing device according to claim 1 further comprising the reception antenna.

19. An information processing method comprising by an arithmetic processing device, making a use determination on a radio wave arrival angle on a basis of a plurality of pieces of phase information, each of the plurality of pieces of phase information being phase information of a signal propagation path for each set of a transmission antenna and a reception antenna, and being calculated for a corresponding frequency of a wireless signal propagated through the signal propagation path.

20. A program readable by a computer device, the program causing the computer device to realize a function of making a use determination on a radio wave arrival angle on a basis of a plurality of pieces of phase information, each of the plurality of pieces of phase information being phase information of a signal propagation path for each set of a transmission antenna and a reception antenna, and being calculated for a corresponding frequency of a wireless signal propagated through the signal propagation path.
